(19) United States
(12) Patent Application Publication
(10) Pub. No.: US 2025/0247815 A1
(43) Pub. Date: Jul. 31, 2025

(54) DETECTING AND PREVENTING UNAUTHORIZED USE OF STANDARD POWER ACCESS POINTS IN MOVING APPLICATIONS

(71) Applicant: Cisco Technology, Inc., San Jose, CA (US)

(72) Inventors: Sachin D. WAKUDKAR, St-Sulpice (CH); Evgeny YANKEVICH, Beachwood, OH (US); Ardalan ALIZADEH, Campbell, CA (US); Peiman AMINI, Fremont, CA (US); Arya FALLAHI, Oberengstringen (CH)

(21) Appl. No.: 18/422,891

(22) Filed: Jan. 25, 2024

(51) Int. Cl. H04W 64/00; H04W 52/28; H04W 88/10

(52) U.S. Cl. CPC H04W 64/003; H04W 52/288; H04W 88/10

(57) ABSTRACT

Techniques and systems for detecting and preventing unauthorized use of standard power operation by access points in moving applications are described. An example technique includes detecting movement of an access point operating in standard power mode. The operation of the AP is modified in response to detecting the movement.

### TECHNICAL FIELD

Embodiments presented in this disclosure generally relate to wireless communication. More specifically, embodiments disclosed herein relate to techniques for detecting and preventing unauthorized (e.g., illegal) use of standard power operation by access points in moving applications.

### BACKGROUND

A variety of wireless systems use or rely on coordination between systems (or at least awareness of other systems) to mitigate or avoid interference. Such cooperation may be particularly important when different wireless systems use overlapping spectrum. For example, incumbent networks (e.g., licensed cellular networks) may use frequencies that overlap with WiFi access points (APs) using the 6 gigahertz (GHz) band. Automated frequency coordination (AFC) is one approach used to mitigate or prevent interference between such systems. Generally, AFC involves reliance on a database of registered spectrum use (e.g., the bands used in a given area), where other systems (e.g., wireless local area network (WLAN) APs) consult the database to determine whether its operations may interfere with preexisting use (e.g., with cellular networks).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to one embodiment.

FIG. 2 is a flowchart of a method for detecting and preventing unauthorized use of standard power by APs in moving applications, according to one embodiment.

FIG. 3 is a flowchart of another method for detecting and preventing unauthorized use of standard power by APs in moving applications, according to one embodiment.

FIG. 4 illustrates an example computing device, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method. The computer-implemented method includes detecting movement of an access point (AP) operating in standard power mode. The computer-implemented method also includes, in response to detecting the movement, modifying operation of the AP.

Another embodiment described herein is a computing device. The computing device includes one or more memories collectively storing computer-executable instructions, and one or more processors communicatively coupled to the one or more memories. The one or more processors are collectively configured to execute the computer-executable instructions to cause the computing device to perform an operation. The operation includes detecting movement of an access point (AP) operating in standard power mode. The operation also includes, in response to detecting the movement, modifying operation of the AP.

Another embodiment described herein is a non-transitory computer-readable medium. The non-transitory computer-readable medium includes computer-executable instructions, which when collectively executed by one or more processors of a computing system cause the computing system to perform an operation. The operation includes detecting movement of an access point (AP) operating in standard power mode. The operation also includes, in response to detecting the movement, modifying operation of the AP.

Other embodiments provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein.

### Example Embodiments

Wireless communication standards, such as the Institute of Electrical and Electronics Engineers (IEEE) 802.11 technical standard, are continuing to evolve to meet the ever increasing demands of bandwidth intensive and low latency services, such as augmented/extended reality and cloud gaming, as illustrative, non-limiting examples. For example, WiFi 6E, which is an extension to IEEE 802.11ax (also known as WiFi 6), includes 1200 megahertz (MHz) of contiguous spectrum that provides seamless coverage across multiple unlicensed national information infrastructure (U-NII) bands, such as U-NII-5, U-NII-6, U-NII-7, and U-NII-8.

WiFi 6E generally defines four separate access classes for WiFi, each with its own rules: (i) standard power (SP) (indoor/outdoor); (ii) low power (indoor) (LPI); (iii) very low power/portable (indoor/outdoor); and (iv) clients (indoor/outdoor). For certain access classes (e.g., standard power), devices (e.g., APs) may have to coordinate with an AFC service/system/operator to determine whether the device is allowed to operate in a desired band, such as the 6 GHz band. For example, there may be one or more incumbent (licensed) users operating in one or more WLAN channels in the 6 GHz band. Such incumbent users may include fixed service(s), satellite service(s), television broadcast service(s), and existing unlicensed users, as illustrative, non-limiting examples. To reduce chances of interference with an incumbent, standard power access generally requires that APs be coordinated through an AFC service/system/operator.

In such a system, each AP may query the AFC service/system/operator in order to evaluate its own use. The AFC service/system/operator may access a database of all licensed users (e.g., Federal Communications Commission (FCC) Universal Licensing System (ULS)) and use the AP's geographical location and antenna characteristics to create a topographical propagation map modeling the AP's interference radius. The topographical propagation map may then be used to coordinate and assign power and channel settings that avoid interference with the incumbent users in the band.

One challenge with current AFC systems is that the AFC systems may not be able to promptly detect when a given AP violates an operating condition associated with SP operation. For example, an AFC system may restrict SP operation to stationary APs to reduce the likelihood of an AP operating in SP moving to a geographical location that interferes with one or more incumbents. For instance, an AFC system may allow AP transmissions at SP levels on frequency channels within the 6 GHz band where the AP will not interfere with incumbents operating in the 6 GHz band. To determine whether an AP has a likelihood of interfering with an incumbent operating within the 6 GHz band, the AFC system may estimate available channels based on the AP's geographical location.

However, in certain scenarios, the AFC system may not be able to promptly determine if and when an AP has moved to a different geographical location associated with incumbent operation. For example, an AP may be expected to update the AFC system whenever the AP has moved to a new geographical location in order to determine the available channels and power level(s) at that geographical location. However, when an AP is rapidly moving (e.g., the AP may be deployed in a moving vehicle), accurate location information may not be available. This, in turn, can lead to the AFC system using stale location information which can lead to interference with incumbents. Additionally, frequently updating the AFC system with location updates can stress the AFC system and result in a denial of service (DOS) attack.

Certain embodiments described herein provide techniques for detecting and preventing unauthorized (e.g., illegal) use of SP operation by APs in moving applications. More specifically, embodiments provide techniques that allow for detecting APs that violate one or more operating conditions associated with SP operation and allow for preventing (or blocking) APs from using SP operation in violation of the one or more operating conditions. The operating conditions may include, for example, an AP that is non-stationary or moving. A reference example of an AP that violates the operating condition(s) may include an AP deployed in an environment that is capable of changing geographical locations, such as a train, plane, automobile, or ship, as illustrative, non-limiting examples. Another reference example of an AP that violates the operating condition(s) may include an AP that has been manually redeployed to a different geographical location associated with incumbent operation.

In certain embodiments described herein, an AP/controller and/or an AFC system may determine whether an AP is in violation of an operating condition associated with SP operation based on one or more location parameters associated with the AP. The location parameters may include location reports from the AP, neighboring AP reports, fine timing measurement (FTM) data, or a combination thereof. After determining that the AP is in violation of an operating condition associated with SP operation, the AP/controller and/or AFC system may perform one or more actions to prevent the AP from using SP operation. Such actions may include, for example, triggering or configuring the AP to operate in a different mode of operation (e.g., LPI mode), triggering or configuring the AP to move to a different frequency band that is not associated with an AFC system (e.g., 5 GHz band, 2.4 GHz band, etc.), or a combination thereof.

The techniques described herein can improve the communication performance (e.g., increased throughput, lower latency, lower interference, etc.) of incumbents operating in the 6 GHz band by limiting or reducing interference to the incumbents caused by APs inappropriately using SP operation.

Note, the techniques described herein for detecting and preventing unauthorized use of SP operation by APs in moving applications may be incorporated into (such as implemented within or performed by) a variety of wired or wireless apparatuses (such as nodes). In some implementations, a node includes a wireless node. Such wireless nodes may provide, for example, connectivity to or for a network (such as a wide area network (WAN) such as the Internet or a cellular network) via a wired or wireless communication link. In some implementations, a wireless node may include a controller, an AP, or an AFC system.

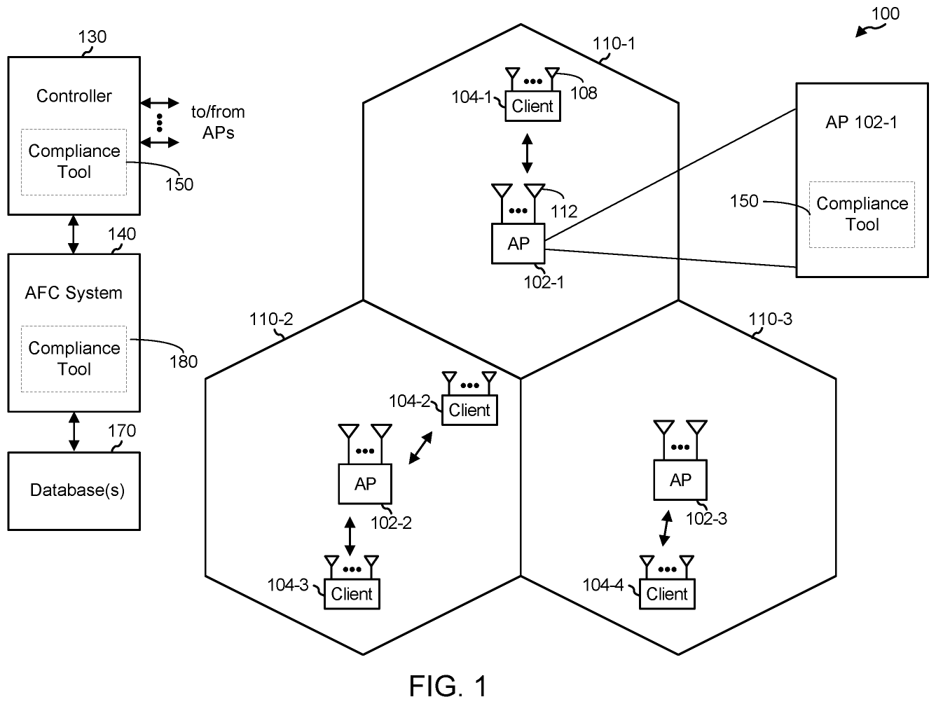

FIG. 1 illustrates an example system in which one or more techniques described herein can be implemented, according to one embodiment. As shown, the system 100 includes, without limitation, one or more APs (e.g., AP 102-1, AP 102-2, and AP 102-3), one or more client STAs (e.g., client STA 104-1, client STA 104-2, client STA 104-3, and client STA 104-4), a controller 130, an AFC system 140, and one or more databases 170.

An AP is generally a fixed station that communicates with client STA(s) and may be referred to as a base station, wireless device, or some other terminology. A client STA may be fixed or mobile and also may be referred to as a mobile STA, a client, a STA, a wireless device, or some other terminology. Note that while a certain number of APs and client STAs are depicted, the system 100 may include any number of APs and client STAs.

As used herein, an AP along with the STAs associated with the AP (e.g., within the coverage area (or cell) of the AP) may be referred to as a basic service set (BSS). Here, AP 102-1 is the serving AP for client STA 104-1, AP 102-2 is the serving AP for client STAs 104-2 and 104-3, and AP 102-3 is the serving AP for client STA 104-4. The AP 102-1, AP 102-2, and AP 102-3 are neighboring (peer) APs. The APs 102 may communicate with one or more client STAs 104 on the downlink and uplink. The downlink (e.g., forward link) is the communication link from the AP 102 to the client STA(s) 104, and the uplink (e.g., reverse link) is the communication link from the client STA(s) 104 to the AP 102. In some cases, a client STA may also communicate peer-to-peer with another client STA.

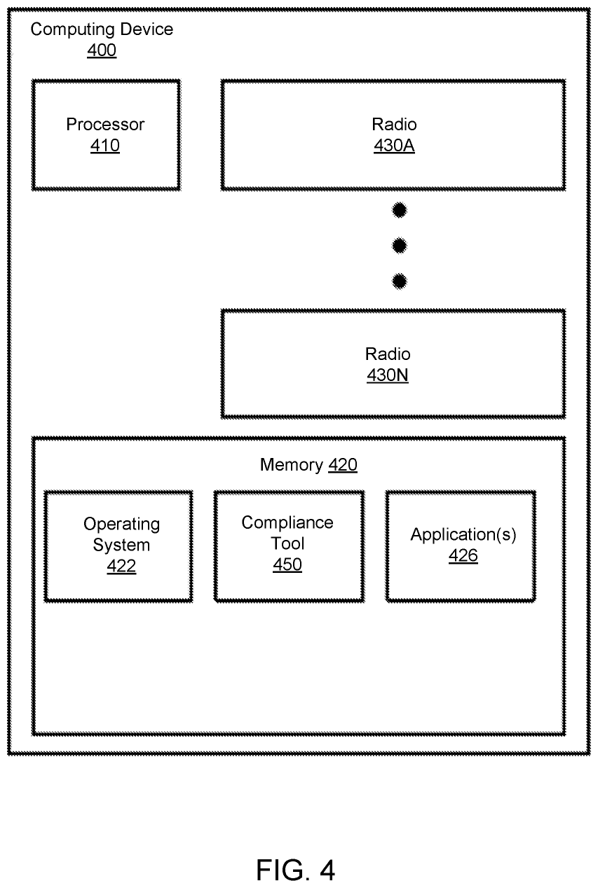

As shown in FIG. 1, each client STA 104 includes one or more radios 108. The client STA 104 can use one or more of the radios 108 to form links with an AP 102. As also shown, each AP 102 includes one or more radios 112 that the AP 102 can use to form links with one or more client STAs 104. In general, the AP(s) 102 and the client STA(s) 104 may form any suitable number of links for communication using any suitable frequencies. In some instances, a client STA 104 may form multiple links with a single AP 102. Example hardware that may be included in an AP 102 is discussed in greater detail in regard to FIG. 4.

In certain embodiments, the APs 102 may be controlled or managed at least partially by the controller 130. Here, the controller 130 couples to and provides coordination and control for the APs 102 1-3. For example, the controller 130 may handle adjustments to RF power, channels, authentication, and security for the APs. The controller 130 may also coordinate the links formed by the client STA(s) 104 with the APs 102.

The operations of the controller 130 may be implemented by any device or system, and may be combined or distributed across any number of systems. For example, the controller 130 may be a WLAN controller for the deployment of APs 102 within the system 100. In some examples, the controller 130 is included within or integrated with an AP 102 and coordinates the links formed by that AP 102 (or otherwise provides control for that AP). For example, each AP 102 may include a controller that provides control for that AP. In some examples, the controller 130 is separate from the APs 102 and provides control for those APs. In FIG. 1, for example, the controller 130 may communicate with the APs 102 1-3 via a (wired or wireless) backhaul. The APs 102 1-3 may also communicate with one another, e.g., directly or indirectly via a wireless or wireline backhaul. Example hardware that may be included in a controller 130 is discussed in greater detail with regard to FIG. 4.

The database(s) 170 are generally representative of regulatory database(s), which include information on incumbent users operating in the system 100. One reference example of a database 170 is the FCC ULS, which includes a list of all licensed users operating within one or more geographical areas. The database(s) 170 may be hosted on one or more computing systems (e.g., regulatory server(s)) in a cloud environment.

The APs 102 may be coupled to the AFC system 140 via the controller 130. The AFC system 140 is generally configured to provide each AP with frequency coordination information so as to mitigate interference to incumbent users operating within the system 100. For example, each AP 102 may query the AFC system 140 to determine whether its operations may interfere with an incumbent user. As part of the query, the AP 102 may include its geographical location, antenna characteristics, frequency band(s), and other parameters.

Upon receiving the query, the AFC system 140 may consult the database(s) 170 to determine a set of wireless restrictions (also referred to as allowable wireless parameters) based on the registered/licensed use within the database(s) 170. For example, the AFC system 140 may generate a topographical propagation map modeling the AP's interference radius and may determine the set of allowable wireless parameters (e.g., channel settings, power settings, and other parameters), based on the topographical propagation map. The AFC system 140 may then provide the allowable wireless parameters to the AP 102 directly or via the controller 130. Example hardware that may be included in an AFC system 140 is discussed in greater detail in regard to FIG. 4.

In certain embodiments described herein, the controller 130, APs 102, and/or AFC system 140 can perform one or more techniques to detect and prevent unauthorized use of SP operation by the APs 102. As shown, the controller 130 and/or APs 102 may include a compliance tool 150, which is configured to detect and prevent unauthorized use of SP operation by the APs 102. Similarly, the AFC system 140 includes a compliance tool 180, which is configured to detect and prevent unauthorized use of SP operation by the APs 102. Each of the compliance tool 150 and compliance tool 180 may include hardware, software, or combinations thereof. Note, the compliance tool 150 and the compliance tool 180 are described in greater detail herein.

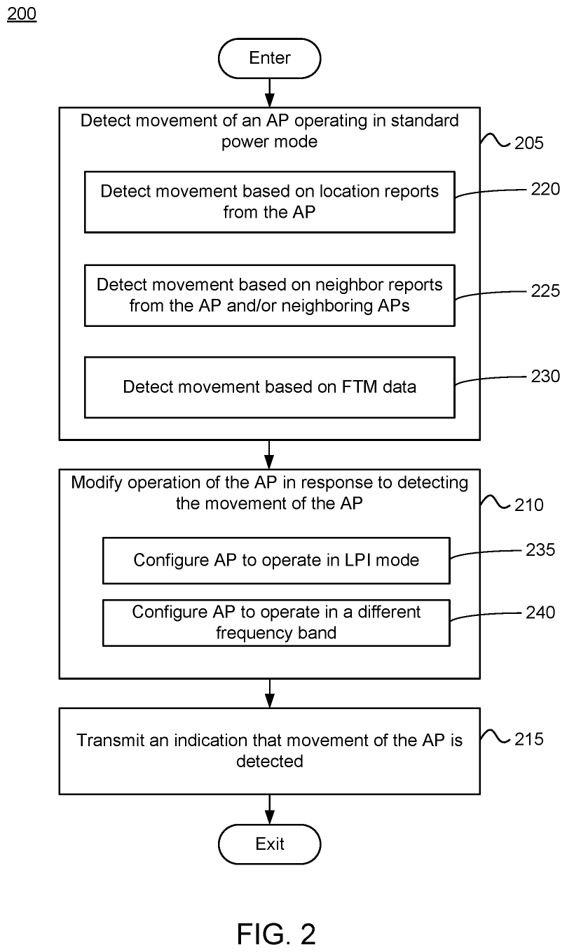

FIG. 2 is a flowchart of a method 200 for detecting and preventing unauthorized use of SP operation by APs in moving applications, according to one embodiment. The method 200 may be performed by a compliance tool (e.g., compliance tool 150). The compliance tool may be implemented within a computing device (or system), such as an AP (e.g., AP 102) or a controller (e.g., controller 130).

Method 200 enters at block 205, where the compliance tool detects movement of an AP operating in SP mode (or operation). Block 205 may include sub-block 220, sub-block 225, sub-block 230, or a combination thereof.

At sub-block 220, the compliance tool detects movement of the AP based on location report(s) received from the AP over a period of time. Each location report may include at least one of: (i) a geographical coordinate of the AP, (ii) a height of the AP, or (iii) an uncertainty region associated with the coordinate of the AP. The uncertainty region generally refers to a geographical region that is indicative of the uncertainty of the reported geographical coordinate. For example, the size of the uncertainty region may cover one or more possible variations of the geographical coordinate reported by the AP (e.g., via a global positioning system (GPS) sensor of the AP) with a certain confidence level (e.g., 95% confidence). The size of an uncertainty region can be in the range of several meters to several hundred meters, depending on satellite visibility of the AP.

In some cases, the compliance tool may consider reported coordinates (e.g., GPS coordinates) that are outside of an initially reported uncertainty region (e.g., the uncertainty region included within the location report) as a new AP location with a corresponding new uncertainty region. For example, assume the compliance tool receives a first location report (with a first AP coordinate, a first AP height, and a first uncertainty region of the first AP coordinate) at a first point in time and a second location report (with a second AP coordinate, a second AP height, and a second uncertainty region of the second AP coordinate) at a subsequent second point in time. Here, if the second AP coordinate is within the first uncertainty region, the compliance tool may not consider the second AP coordinate to be a new AP location. On the other hand, if the second AP coordinate is within the first uncertainty region, the compliance tool may consider the second AP coordinate to be a new AP location.

In certain embodiments, the compliance tool may use an enhanced uncertainty region to detect movement of the AP. The enhanced uncertainty region may be larger than an uncertainty region included within a location report. For example, assuming an uncertainty region included within a location report has 95% confidence, there is a 5% probability that a new reported coordinate is outside the uncertainty region. Accordingly, in certain embodiments, an enhanced uncertainty region with approximately 100% confidence (or, in general, a confidence greater than the confidence of a prior reported uncertainty region) may be used to determine whether new AP coordinates indicate AP movement.

In certain embodiments, the compliance tool may detect movement of the AP based on comparing location reports of the AP over time. For example, the compliance tool may store the location report(s) of each AP in a storage system (e.g., database). Whenever a new location is communicated from a location sensor (e.g., GPS sensor) of the AP, the compliance tool may compare the new location with the previous location and enhanced uncertainty region and determine whether the AP has moved (or is moving) from its previous location. For example, the compliance tool may detect movement of the AP when a distance between a first coordinate of the AP at a first point in time and a second coordinate of the AP at a second point in time is larger than a predefined uncertainty region. The predefined uncertainty region may be larger than the uncertainty region associated with the first coordinate of the AP and the uncertainty region associated with the second coordinate of the AP.

At sub-block 225, the compliance tool detects movement of the AP based on one or more neighbor report(s). In some embodiments, the neighbor report(s) may be received from one or more neighboring APs (e.g., other APs neighboring the AP operating in SP) over a period of time. The compliance tool may use the neighbor discovery protocol to detect movement of the AP. Under the neighbor discovery protocol, a given AP may generate and transmit a neighbor report to the controller (e.g., controller 130) each time a new neighboring AP is detected within proximity (e.g., within a threshold distance) to the AP. The neighbor report may include an estimate of the new neighboring AP's location. Upon receiving the neighbor report, the controller (via the compliance tool) may initiate an AFC query to the AFC system for allowable wireless parameters for the AP at the AP's location. In certain embodiments, the compliance tool may keep track of location changes triggered for a given AP, based on neighbor reports received from neighboring APs of that AP over a period of time. The compliance tool may detect movement of the AP if the number and/or frequency of location changes (indicated via the neighbor discovery protocol) is greater than a threshold.

Additionally or alternatively, in certain embodiments, the neighbor report(s) may be received from an AP operating in SP mode. For example, the compliance tool can compare the neighbors reported by an AP operating in SP mode over time to determine if the AP is moving. If the reported neighbors are different over time and fall in different geographical areas (e.g., outside an uncertainty region or an enhanced uncertainty region), then the compliance tool may determine that the AP is moving.

At sub-block 230, the compliance tool detects movement of the AP based on FTM data. WiFi FTM generally uses round-trip time-of-flight measurements to determine the distance between two nodes. In some embodiments, FTM can be used to determine the distance between APs and infer a given AP's location. If the compliance tool determines that the AP's location (inferred based on FTM data) is changing, then the compliance tool may determine that the AP is moving.

At block 210, the compliance tool modifies operation of the AP in response to detecting movement of the AP. Block 210 may include sub-block 235, sub-block 240, or a combination thereof. At sub-block 325, the compliance tool configures the AP to operate in LPI mode as opposed to SP mode. At sub-block 240, the compliance tool configures the AP to operate in a different frequency band (e.g., 5 GHz band) than the 6 GHz band which is generally associated with incumbent operation.

At block 215, the compliance tool transmits an indication that movement of the AP is detected to a computing system (e.g., AFC system 140).

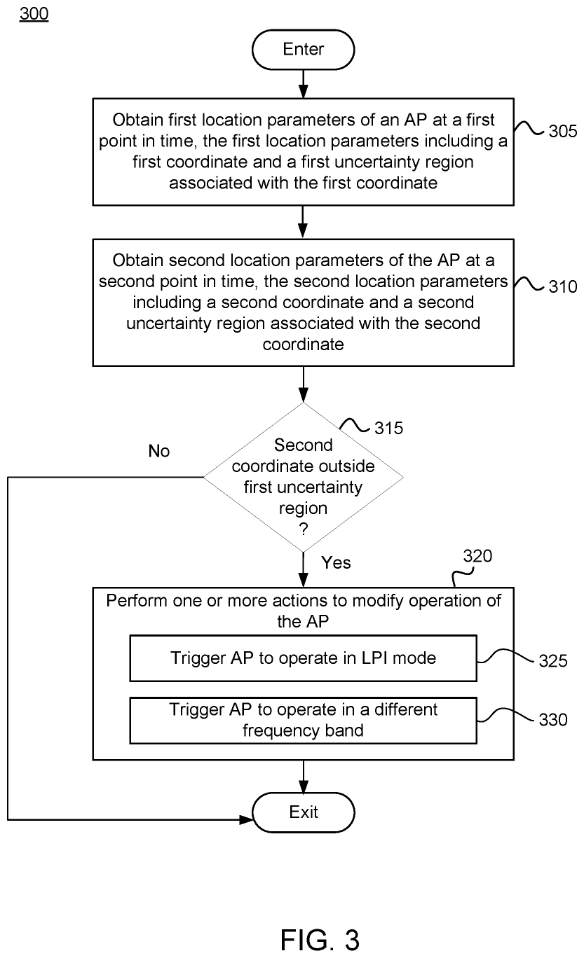

FIG. 3 is a flowchart of a method 300 for detecting and preventing unauthorized use of SP operation by APs in moving applications, according to one embodiment. The method 300 may be performed by a compliance tool (e.g., compliance tool 180). The compliance tool may be implemented within a computing device (or system), such as AFC (computing) system (e.g., AFC system 140).

Method 300 may enter at block 305, where the compliance tool obtains first location parameters of an AP at a first point in time. The first location parameters may include at least one of: (i) a first geographical coordinate of the AP, (ii) a first height of the AP, or (iii) a first uncertainty region associated with the first geographical coordinate of the AP.

At block 310, the compliance tool obtains second location parameters of the AP at a second point in time subsequent to the first point in time. The second location parameters may include at least one of: (i) a second geographical coordinate of the AP, (ii) a second height of the AP, or (iii) a second uncertainty region associated with the second geographical coordinate of the AP.

At block 315, the compliance tool determines whether the second geographical coordinate is outside the first uncertainty region. If so, then the method 300 proceeds to block 320. Note, in certain embodiments, the compliance tool may compare the second geographical coordinate to an enhanced uncertainty region that is larger than the first uncertainty region. In such embodiments, if the compliance tool determines the second geographical coordinate is outside the enhanced uncertainty region, then the method 300 proceeds to block 320.

At block 320, the compliance tool performs one or more actions to modify the operation of the AP. Block 320 may include sub-block 325, sub-block 330, or a combination thereof. At sub-block 325, the compliance tool triggers the AP to operate in LPI mode. For example, the compliance tool may send a command to the controller (e.g., controller 130) associated with the AP and/or to the AP to configure the AP to switch from operating in SP mode to operating in LPI mode (or another mode). At sub-block 330, the compliance tool triggers the AP to operate in a different frequency band (e.g., 5 GHZ band) than the 6 GHz band. For example, the compliance tool may send a command to the controller (e.g., controller 130) associated with the AP and/or to the AP to configure the AP to switch from operating in the 6 GHz band to operating in a different frequency band.

FIG. 4 illustrates an example computing device 400, according to one embodiment. The computing device 400 can be configured to perform one or more techniques described herein for detecting and preventing unauthorized use of SP mode by APs in moving applications. For example, the computing device 400 can perform method 200, method 300, and any other techniques (or combination of techniques) described herein. The computing device 400 can be an AFC system (e.g., AFC system 140), a controller (e.g., controller 130), or an AP (e.g., AP 102). The computing device 400 includes, without limitation, a processor 410, a memory 420, and one or more radios 430a-n (generally, radio 430).

The processor 410 may be any processing element capable of performing the functions described herein. The processor 410 represents a single processor, multiple processors, a processor with multiple cores, and combinations thereof. The communication interfaces 430 facilitate communications between the computing device 400 and other devices. The communications interfaces 430 are representative of wireless communications antennas and various wired communication ports. The memory 420 may be either volatile or non-volatile memory and may include RAM, flash, cache, disk drives, and other computer readable memory storage devices. Although shown as a single entity, the memory 420 may be divided into different memory storage elements such as RAM and one or more hard disk drives.

As shown, the memory 420 includes various instructions that are executable by the processor 410 to provide an operating system 422 to manage various functions of the computing device 400. The memory 420 also includes a compliance tool 450 configured to perform one or more techniques described herein, and one or more application(s) 426. In certain embodiments, the compliance tool 450 is representative of the compliance tool 150. In other embodiments, the compliance tool 450 is representative of the compliance tool 180.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method comprising:
detecting movement of an access point (AP) operating in standard power mode; and
in response to detecting the movement, modifying operation of the AP.

2. The computer-implemented method of claim 1, further comprising receiving one or more reports from the AP over a period of time, wherein the movement of the AP is detected based on the one or more reports.

3. The computer-implemented method of claim 2, wherein each of the one or more reports comprises at least one of (i) a coordinate of the AP, (ii) a height of the AP, or (iii) an uncertainty region associated with the coordinate of the AP.

4. The computer-implemented method of claim 3, wherein detecting movement of the AP comprises determining that a distance between a first coordinate of the AP at a first point in time and a second coordinate of the AP at a second point in time is larger than a predefined uncertainty region.

5. The computer-implemented method of claim 4, wherein the predefined uncertainty region is larger than each of a first uncertainty region associated with the first coordinate of the AP and a second uncertainty region associated with the second coordinate of the AP.

6. The computer-implemented method of claim 1, further comprising receiving one or more reports from the AP indicating one or more neighboring APs associated with the AP, wherein the movement of the AP is detected based on the one or more reports.

7. The computer-implemented method of claim 6, wherein detecting movement of the AP comprises determining that a number of neighboring APs that are different from a first report at a first point in time and a second report at a second point in time is greater than a threshold.

8. The computer-implemented method of claim 1, further comprising receiving one or more reports from one or more neighboring APs associated with the AP, wherein the movement of the AP is detected based on the one or more reports.

9. The computer-implemented method of claim 8, wherein detecting movement of the AP comprises determining that a number of the one or more reports received over a period of time is greater than a threshold.

10. The computer-implemented method of claim 1, further comprising receiving one or more reports from the AP, each report comprising fine timing measurement data, wherein the movement of the AP is detected based on the one or more reports.

11. The computer-implemented method of claim 1, wherein modifying operation of the AP comprises configuring the AP to operate low power indoor mode from standard power mode.

12. The computer-implemented method of claim 1, wherein modifying operation of the AP comprises configuring the AP to operate in a different frequency band.

13. A computing device comprising:
one or more memories collectively storing computer-executable instructions; and
one or more processors communicatively coupled to the one or more memories, the one or more processors being collectively configured to execute the computer-executable instructions to cause the computing device to perform an operation comprising:
detecting movement of an access point (AP) operating in standard power mode; and
in response to detecting the movement, modifying operation of the AP.

14. The computing device of claim 13, the operation further comprising receiving one or more reports from the AP over a period of time, wherein the movement of the AP is detected based on the one or more reports.

15. The computing device of claim 14, wherein each of the one or more reports comprises at least one of (i) a coordinate of the AP, (ii) a height of the AP, or (iii) an uncertainty region associated with the coordinate of the AP.

16. The computing device of claim 15, wherein detecting movement of the AP comprises determining that a distance between a first coordinate of the AP at a first point in time and a second coordinate of the AP at a second point in time is larger than a predefined uncertainty region.

17. The computing device of claim 16, wherein the predefined uncertainty region is larger than each of a first uncertainty region associated with the first coordinate of the AP and a second uncertainty region associated with the second coordinate of the AP.

18. The computing device of claim 13, the operation further comprising further comprising receiving one or more reports from the AP indicating one or more neighboring APs associated with the AP, wherein:
the movement of the AP is detected based on the one or more reports; and
detecting movement of the AP comprises determining that a number of neighboring APs that are different from a first report at a first point in time and a second report at a second point in time is greater than a threshold.

19. The computing device of claim 13, wherein modifying operation of the AP comprises at least one of configuring the AP to operate low power indoor mode from standard power mode or configuring the AP to operate in a different frequency band.

20. A non-transitory computer-readable medium comprising computer-executable instructions, which when collectively executed by one or more processors of a computing system cause the computing system to perform an operation comprising:
detecting movement of an access point (AP) operating in standard power mode; and
in response to detecting the movement, modifying operation of the AP.
